(19) United States
(12) Patent Application Publication
(10) Pub. No.: US 2011/0293120 A1
(43) Pub. Date: Dec. 1, 2011

(54) EARPHONE TRANSDUCER

(76) Inventor: Timothy Val Kolton, Los Angeles, CA (US)

(21) Appl. No.: 12/786,994

(22) Filed: May 25, 2010

(51) Int. Cl. H04R 25/00

(52) U.S. Cl. 381/184

(57) ABSTRACT

An improved earphone transducer made of a first ring-shaped diaphragm covering the area of the earphone transducer perimeter to the transducer voice coil, and a second dome-shaped transducer covering the center space above the voice coil. The ring-shaped diaphragm and dome-shaped diaphragm have overlapping areas to facilitate integration into the transducer, and the dome shaped diaphragm has a surface anomaly at its apex to facilitate manufacture. The diaphragms are of differing thicknesses and/or hardness to produce a more dynamic sound response, and may also be made of different thermoplastic materials.

### BACKGROUND

Headphone transducers translate electrical signals into sound using very small magnetic drivers. While some headphone transducers use balanced armatures to achieve diaphragm vibration, most headphones employ a traditional ring-shaped voice coil similar to voice coils found in speakers. Due to the small size of headphone and earphone voice coils and diaphragms, sound performance tends to be inferior to hi-fidelity speakers. Additionally, headphone transducers can be difficult to manufacture due to their small size.

Existing devices use a variety of techniques to overcome fidelity limitations. U.S. Pat. No. 7,428,946 to Honda et al. discloses a transducer with a suspension characterized by boundary sections to strengthen the transducer bead. U.S. Pat. No. 7,266,213 to Furuya discloses a transducer with a diaphragm affixed to a case periphery to increase the diaphragm diameter. U.S. Pat. No. 7,010,140 to Furuya discloses a transducer providing sound discharge holes to prevent phase cancellation. U.S. Pat. No. 6,920,230 to Usuki et al. discloses a transducer employing a magnetically charged 2^{nd} diaphragm which reacts according to changing magnetic flux.

None of these devices use transducer diaphragms of different thicknesses and different hardness, nor do they employ multiple connected transducer diaphragms. Complex multiple diaphragm designs have heretofore been avoided due to high manufacturing cost. Single diaphragm designs are easier to manufacture and install on earphone assemblies.

It is therefore an object of the present invention to provide a transducer with multiple diaphragms of different materials and or thicknesses to increase fidelity. Another object of the invention is to overcome problems associated with manufacturing transducers using multiple diaphragms. These and other objects of the invention will become better understood through the following summary, description and claims.

### SUMMARY

An improved earphone transducer for headphones using diaphragm transducers includes a voice coil, a first, ring-shaped diaphragm and a second, dome shaped diaphragm. The diaphragms are of differing thickness and construction to produce superior audio fidelity. The voice coil interfaces with a conventional earphone driver, having a stepped area around its top rim. The stepped area is preferably higher toward the inner side of the voice coil and lower toward the voice coil's outer side.

The first diaphragm is ring shaped, elevated in the middle, and having two flat edges. The outer edge adheres to the outer edge of an earphone transducer assembly and the inner edge engages the stepped area of the voice coil. The second diaphragm is dome shaped, also with a substantially flattened portion around the edge. Ideally, the second diaphragm is slightly larger than the first diaphragm, allowing the edges to be adhesively connected at the juncture of the first diaphragm inner edge and voice coil. The second diaphragm also has a small node or bulge at the top. The bulge allows the second diaphragm to be accurately located in position as the transducer is manufactured.

The first diaphragm, in addition to the flat portions at the outer and inner edges, also has a series of grooves running from its outer edge to inner edge. The grooves run at oblique angles to facilitate deformation of the first diaphragm, and enabling it to produce superior sound reproduction. In one embodiment, the flattened portion of the first diaphragm's inner edge is the same width as the flattened portion of the second diaphragm's outer edge. Preferably, the second diaphragm's outer edge is larger than the first diaphragm's inner edge in order to overlap. Also, the transducer may have the outer edge of the second diaphragm adhered to the transducer coil, and the inner edge of the first diaphragm adhered to the outer edge of the second diaphragm.

For optimum sound reproduction, the first diaphragm is preferably a different thickness and different hardness than the second diaphragm, allowing the diaphragms to have different vibration characteristics. The inner edge of the first diaphragm may also be made in different shapes such as round, ellipse or square. It is contemplated that both the first diaphragm and second diaphragm may be made of thermoplastic materials such as polyethylene terephthalate (PET), polyarylate (PAR), polyphenylene sulfide (PPS), and/or polyethylene naftalate (PEN) among others.

### BRIEF DESCRIPTION OF THE FIGURES

FIG. 1 is an exploded view of the earphone transducer of the present invention.

FIG. 2 is a perspective view of the first diaphragm and second diaphragm of the of the earphone transducer.

FIG. 3 is a perspective view of the first and second diaphragm of the earphone transducer in an assembled configuration.

FIG. 4 is a perspective view of the second diaphragm of the earphone transducer attached to an earphone assembly fixture.

### DESCRIPTION

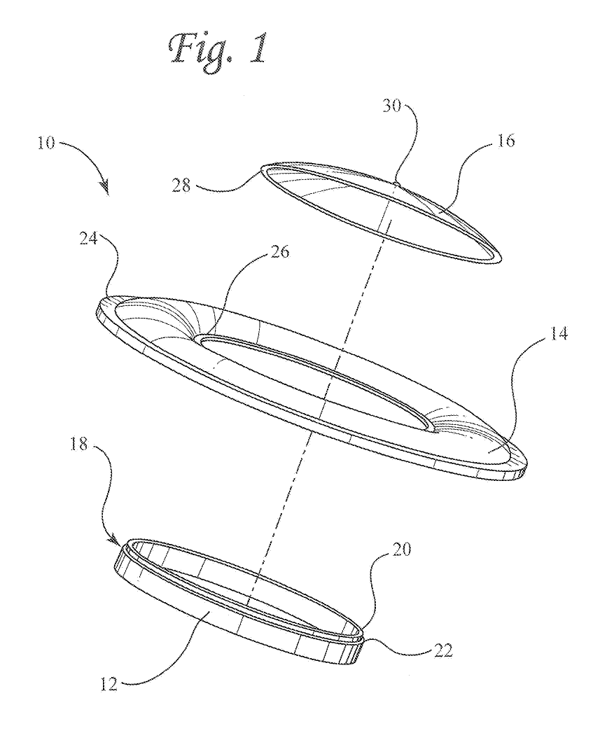

Referring to FIG. 1, an improved earphone transducer for headphones using diaphragm transducers is shown and described. The earphone transducer 10 comprises a voice coil 12, a first diaphragm 14 which is ring-shaped, and a second diaphragm 16 which is dome shaped. The voice coil 12 is adapted to interface with a conventional earphone voice coil driver. The voice coil 12 structure also comprises a stepped area 18 disposed around the top of the voice coil 12. The stepped area 18 is preferably higher toward the inner side of the voice coil 20 and lower toward the outer side 22 of the voice coil 20.

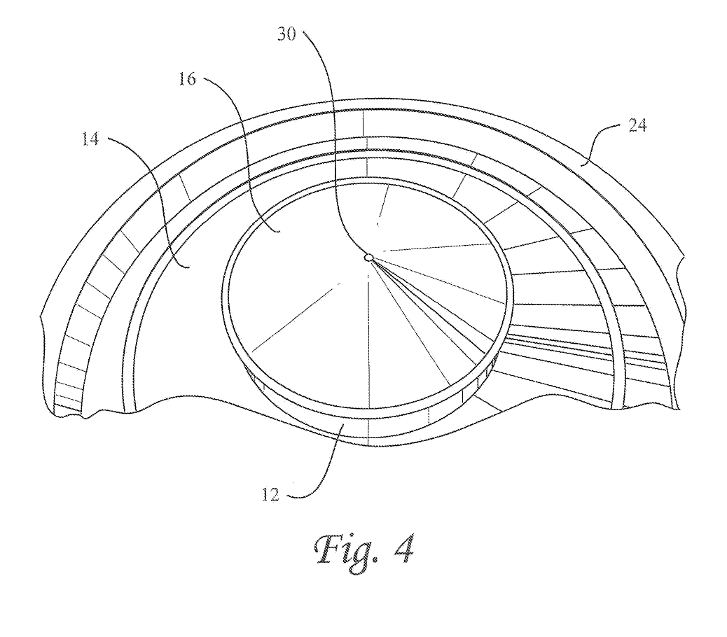

Still referring to FIG. 1, the first diaphragm 14 comprises substantially an annular shape having a toroidal arc around its circumference. The first diaphragm 14 has an outer edge 24 and an inner edge 26. The outer edge 24 is flattened and adapted to adhere to an earphone transducer assembly outer edge 34, shown in FIG. 4. The inner edge 26 is flattened and adapted to engage the stepped area 18 on the voice coil 12.

Still referring to FIG. 1, the second diaphragm 16 comprises a dome shaped member with a substantially flattened perimeter 28. Ideally, the perimeter 28 is slightly larger than the inner edge 26 of the first diaphragm 14, allowing the perimeter 28 to be adhesively connected to the inner edge 26 at the juncture of the inner edge 26 and voice coil 12. The second diaphragm also comprises a physical deformation, or point 30 at its apex. The point 30 is preferably a small bulge in the surface of the second diaphragm 16 detectable from both sides of the second diaphragm 16, which can be used to locate the second diaphragm 16 in the proper position relative to the first diaphragm 14 during manufacture. The point 30, comprising a bulge on the top of the second diaphragm 16 may also present an indentation on the bottom side of the second diaphragm 16.

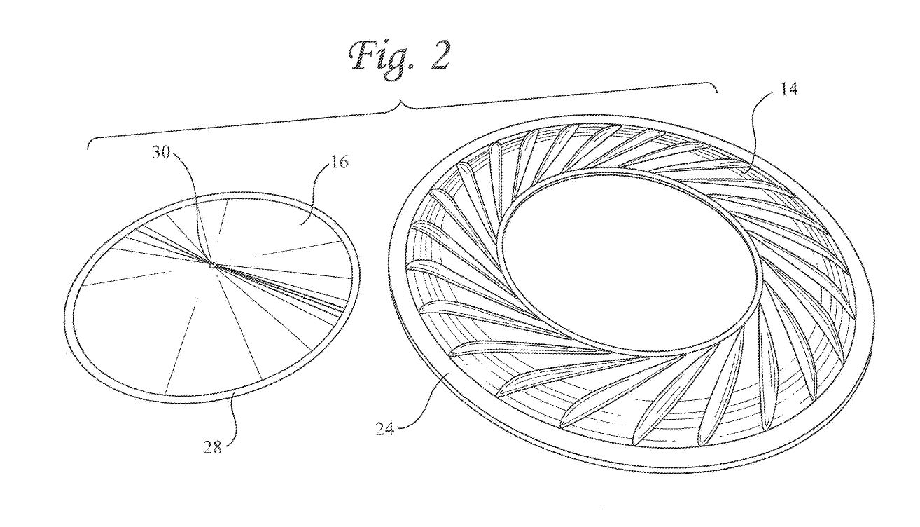

Referring to FIG. 2, the first diaphragm 14 and second diaphragm 16 are shown side by side in a disassembled state. The first diaphragm 14, in addition to the flat portions at the outer edge 24 and inner edge 26, comprises a series of grooves 32 that run from the outer edge 24 to the inner edge 26. The grooves 32 are preferably disposed at an oblique angle to facilitate deformation of the first diaphragm 14 when in operation. Preferably, the first and second diaphragms have different thicknesses and/or different hardnesses.

Still referring to FIG. 2, the flattened portion of the inner edge 26 of the first diaphragm 14 is of substantially the same thickness as the flattened portion of the outer edge 28 of the second diaphragm 16. Preferably, the outer edge 28 of the second diaphragm 16 is larger than the inner edge 26 of the first diaphragm 14 so that the edges overlap. The transducer may have the outer edge of the second diaphragm adhered to the transducer coil, and the inner edge of the first diaphragm adhered to the outer edge of the second diaphragm. Since the first diaphragm 14 and second diaphragm 16 can be of differing thicknesses, it is anticipated that the outer edge 28 and inner edge 26 will have corresponding differing thicknesses.

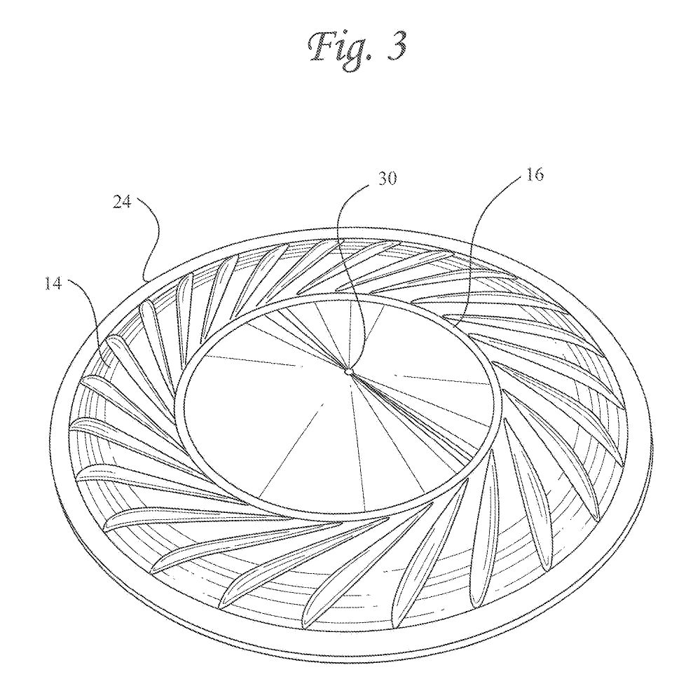

Referring to FIG. 3, a perspective view of the first diaphragm 14 and second diaphragm 16 being assembled is shown. Preferably, the outer edge of the second diaphragm is adhered to the inner edge of the first diaphragm with an adhesive. In various embodiments, the outer edge 28 of the second diaphragm 16 may be above or below the inner edge 26 of the first diaphragm 14.

Referring to FIG. 4, a perspective view of the second diagram 16 as installed on the voice coil 12 of an assembly fixture 32 is shown. The second diaphragm 16 adheres to the voice coil 12. The first diaphragm 14 may then be adhered over the second diaphragm 16 and the edge 34 of the assembly fixture 32. Preferably the first diaphragm 14 and second diaphragm 16 adhere to the assembly fixture 32 and voice coil 12 in an air-tight manner.

In a preferred embodiment, for optimum sound reproduction characteristics, the first diaphragm is of a different thickness and different hardness than the second diaphragm. Because of the difference in thickness, the diaphragms will have different vibration characteristics. Additionally, the inner edge of the first diaphragm may comprise round, ellipse or square shape. It is contemplated that both the first diaphragm and second diaphragm may comprise a material such as polyethelene terephthalate (PET), polyarylate (PAR), and/or polyphenylene sulfide (PPS) among others.

Although the present invention has been described in considerable detail with reference to certain preferred versions thereof, other versions are possible. For instance the escutcheon and base assembly may be used for outdoor fixtures, and other areas where a tool-less quick disassembly is desirable. Therefore, the spirit and scope of the appended claims should not be limited to the description of the preferred versions contained herein.

Any element in a claim that does not explicitly state “means for” performing a specified function, or “step for” performing a specific function, is not to be interpreted as a “means” or “step” clause as specified in 35 U.S.C. §112, ¶6. In particular, the use of “step of” in the claims herein is not intended to invoke the provisions of 35 U.S.C. §112, ¶6.

What is claimed is:

1. An improved earphone transducer for headphones having diaphragm transducers comprising:
a transducer coil adapted for insertion into a magnetic gap;
a first diaphragm comprising a ring shaped member having an outer edge adapted for fixation to an earphone assembly, and having an inner edge adapted for affixing to said transducer coil; and
a second diaphragm comprising a dome shaped member, said dome shaped member having an outer edge adapted for affixing to the inner edge of said first diaphragm, said second diaphragm comprising a deformation at its apex adapted to be align the second diaphragm in position during manufacture.

2. The earphone transducer of claim 1 wherein said transducer coil comprises a step structure along its top edge for accommodating the inner edge of said first diaphragm and the outer edge of said second diaphragm.

3. The earphone transducer of claim 1 wherein the inner edge of said first diaphragm comprises a flat planar ring surface thereby allowing the planar ring surface to adjoin said transducer coil.

4. The earphone transducer of claim 1 wherein the outer edge of said second diaphragm comprises a flat planar ring surface adapted to adjoin the inner edge of said first diaphragm.

5. The earphone transducer of claim 1 wherein the outer edge of said second diaphragm overlaps said inner edge of said first diaphragm.

6. The earphone transducer of claim 1 wherein the outer edge of said second diaphragm is larger in diameter than the inner edge of said first diaphragm.

7. The earphone transducer of claim 6 wherein the outer edge of said second diaphragm is adhered to the inner edge of said first diaphragm with adhesive.

8. The earphone transducer of claim 1 wherein said deformation comprises an indentation and bulge in the surface of said second diaphragm.

9. The earphone transducer of claim 1 wherein the thickness of the first diaphragm differs from the thickness of the second diaphragm.

10. The earphone transducer of claim 1 wherein the hardness of the first diaphragm differs from the hardness of the second diaphragm.

11. The earphone transducer of claim 1 wherein said first diaphragm and said second diaphragm have different vibration characteristics.

12. The earphone transducer of claim 1 wherein the inner edge of said first diaphragm comprises a shape chosen from the list of; round, ellipse or square.

13. The earphone transducer of claim 1 wherein said first diaphragm is composed of a material chosen from the list of polyethelene terephthalate (PET), polyarylate (PAR), and polyphenylene sulfide (PPS).

14. The earphone transducer of claim 1 wherein said second diaphragm is composed of a material chosen from the list of polyethelene terephthalate (PET), polyarylate (PAR), and polyphenylene sulfide (PPS).

15. The earphone transducer of claim 1 wherein the outer edge of said second diaphragm is adhered to said transducer coil, and said inner edge of said first diaphragm is adhered to said outer edge of said second diaphragm.

16. The earphone transducer of claim 1 wherein said first diaphragm comprises a surface with grooves disposed therein.

17. The earphone transducer of claim 16 wherein said grooves extend from the inner edge to the outer edge of said first diaphragm.
